(19) United States
(12) Patent Application Publication
(10) Pub. No.: US 2017/0119021 A1
(43) Pub. Date: May 4, 2017

(54) MODIFIED ANTHOCYANIN COLORING AGENT

(71) Applicant: D.D. Williamson & Co., Inc., Louisville, KY (US)

(72) Inventor: Ashok Luhadiya, Cincinnati, OH (US)

(21) Appl. No.: 14/932,004

(22) Filed: Nov. 4, 2015

(51) Int. Cl. A23L 1/275

(52) U.S. Cl. CPC A23L 1/2751; A23V 2002/00

(57) ABSTRACT

An anthocyanin-based coloring agent having a lower λmax and thus a reduction in blueness and an increase in yellowness, with increased chroma, hue and redness is formed by combining the aqueous-based anthocyanin coloring agent with an aqueous sorghum extract. The ratio of anthocyanin to sorghum extract in terms of color unit can be from 35:1 to 1:5. This can be used in a wide variety of edible products including foods, nutraceuticals and pharmaceutical products and formulations, wherever an aqueous-based coloring agent is preferred.

### BACKGROUND OF THE INVENTION

Anthocyanic pigments are used as coloring agents for various foods, confectioneries, beverages, nutraceutical and pharmaceutical products. Anthocyanins can be extracted from fruits, vegetables or other plant sources. Many of the sources of anthocyanin include elderberry, purple corn, purple potato, black carrot, radish, red cabbage, hibiscus, black currant and like. Generally, anthocyanins from plant sources tend to have a purple/red hue and a lower chroma. In many applications, it is preferred to have an anthocyanin derived coloring agent that has more red hue and less blue or purple hue.

The phenomenon of co-pigmentation of anthocyanins and anthocyanidins is well known and is due to molecular associations between pigment and other organic compounds in solution. The association of pigment and their co-pigmentation factors involves anthocyanin glucosides and certain phenolic acids, flavonoids, and certain aldehydes. The association results in higher absorbance values (a hyperchromic shift). Certain cofactors cause a bathochromatic shift in the wavelength with maximum absorbance (λmax) typically 5 to 20 nm higher, providing a blue-purple tone. (Reference: Boulton, R. Am. J. Enol. Vitic. 52:2, 2001).

Safi et al (J. Agri. Food Chem 48, 5946-5954, 2000) studied the reactions between (+)-Catechin and Furfural derivatives and observed bathochomatic shift towards longer wavelength for malvidin-3-O-glucoside.

Eiro et al (J. Agri. Food Chem. 50, 7461-7466, 2002) evaluated ferulic acid and rosmarinic acid interaction with anthocyanins and observed bathochromatic shift towards longer wavelength as well as hyperchromic effect, increase in absorbance.

U.S. Pat. No. 4,285,982 describes improved sunlight stability of anthocyanins and bathochromatic shift towards higher λmax by incorporating sulfonated polyhydroxy flavonols, polyhydroxyflavones and their derivatives.

U.S. Pat. No. 4,481,226 describes heat and light stabilization of grape anthocyanins by combining with tannic acid.

U.S. Pat. No. 5,908,650 discloses that addition of certain flavonoids glucuronides and caffeic acid derivatives from a variety of plant sources to anthocyanins causes a bathochromic shift towards longer wavelength and hyperchromic shift in the absorption spectrum of anthocyanins; and improves stability to pH, heat and/or light. As disclosed in the '650 patent, various plant extracts can be combined with anthocyanins to cause co-pigmentation. U.S. Pat. No. 5,908,650 does not show or suggest that various plant extract sources evaluated result in bathochromatic shift towards shorter wavelength.

U.S. Pat. No. 8,425,960 describes anthocyanin compositions forming blue hue resulting from bathochromatic shift by reacting with glyoxalic acid. The bathochromic process results in b* reduction compared to unmodified anthocyanin by using 1976 CIE L*a*b* model system.

In general, the known effects of co-pigmentation results in an anthocyanin that has a λmax at higher wavelength, which is undesirable in certain circumstances, making the coloring agent unsuitable for certain applications wherein a redder color is preferred, which is one with a lower λmax.

### SUMMARY OF THE INVENTION

The present invention stems from a realization that the λmax of anthocyanin coloring agents can be reduced by combining the anthocyanin with an aqueous sorghum extract resulting in more redness and reduced blue/purple hue. Unlike other plant extracts, sorghum extract has been found to reduce the λmax while, at the same time, increasing the chroma. Further, there is an increase in hue, which results in increased redness.

The present invention provides a composition for producing anthocyanin extract from various plant sources having increased red hue and reduced blue/purple hue by combining with sorghum extract in the ratio of anthocyanin to sorghum extract from 35:1 to 1:5, based on color units.

The objects and advantages of the present invention will be further appreciated in light of the following detailed description.

### DETAILED DESCRIPTION

In the present invention, color content is expressed in color units. The color content of clear extracts is determined by suitably diluting the extract with 2.2 molar pH 3 citrate buffers and reading absorbance at λmax, with a UV-visible spectrophotometer. The color units are then equal to λmax minus λ700 multiplied by a dilution factor. The λmax, in turn, is the wavelength at the highest absorbance. The present invention is a combination of an aqueous solution of anthocyanin, preferably extracted from a plant, in combination with an aqueous extract of sorghum, such as black and red sorghum.

The source of the anthocyanin can be virtually any known anthocyanin extract. These can, for example, be extracted from elderberries, purple corn, purple potato, black carrot, radish, currants, red cabbage and many other generally red or purple plants. The extract is obtained by simply grinding the source material and combining this with water, with or without the aid of acid and at elevated temperature. Extracts of anthocyanins from various plant sources are commercially available.

The sorghum extract is extracted from either sorghum bran or sorghum whole-grain, generally using an acidic aqueous medium. For example, 20 grams of sorghum bran can be extracted with 400 mL of 1% phosphoric acid at 80° C. for sixty minutes. This can be filtered and centrifuged and decanted to provide a clear extract. The clear extract may be further concentrated.

To form the modified anthocyanin of the present invention, the sorghum extract is combined with the anthocyanin with mixing. The ratio in color units of anthocyanin to sorghum can be from 35 to 1; 33 to 1; 25 to 1; 20 to 1; 15 to 1; 10 to 1; 5 to 1; 1 to 1; 1 to 1.5 or 1 to 2; 1; 3 to 1; 4 to 1; 5.

Once mixed, the pH of the mix is adjusted, generally to an acidic pH of 1.5 to 6 or 2 to 5, or 2.5 to 4. This is then allowed to stand during which period the color of the mix changes from purple-red to orange-red/red and the chroma increases significantly. The blend can stand at a temperature of 55° F. to 140° F. for a period of 1 to 24 hours to develop its final color. The coloring agent can be incorporated into an aqueous or alcohol-based syrup or concentrate or can be dried to form a powder. The edible coloring agent can be added to foods and beverages at any stage of production of the food or beverage. It can be used as a potential replacement for FD&C Red #40. The invention will be further appreciated in the following detailed examples.

### Example 1

An elderberry extract was combined with sorghum extract at a ratio or color units of 1 to 1. The sorghum extract increased the hue from 25.18 to 52.05, and the chroma from 62.97 to 93.73. Similarly, a sorghum extract was combined with a purple corn extract at a ratio of 1 to 1. This increased the hue from 21.98 to 44.7 and the chroma from 53.84 to 82.13. The sorghum extract had an initial hue of 69.01, and a chroma of 62.98. The following Table 1 shows a comparison of the individual elderberry and purple corn extracts with the extracts in combination with the sorghum extract.

TABLE 1

| | L | a | b | C | h |
|---|---|---|---|---|---|
| Elderberry Extract EB) | 64.01 | 56.99 | 26.8 | 62.97 | 25.18 |
| Elderberry Extract (EB) + | 59.27 | 57.59 | 73.94 | 93.73 | 52.09 |
| Sorghum Extract | | | | | |
| Purple Corn Extract PCE) | 60.66 | 49.92 | 20.15 | 53.84 | 21.98 |
| Purple Corn Extract PCE) + | 52.09 | 58.28 | 57.77 | 82.13 | 44.7 |
| Sorghum Extract | | | | | |

Table 2 shows the λmax at a pH of 3 of the individual anthocyanin extracts, as well as the anthocyanin extracts in combination with the sorghum extract.

TABLE 2

| | Absorption Maximum |
|---|---|
| | nm (λmax) at pH 3.0 |
| Elderberry Extract EB) | 513 |
| Elderberry Extract (EB) + | 496.5 |
| Sorghum Extract | |
| Purple Corn Extract PCE) | 513 |
| Purple Corn Extract PCE) + | 504 |
| Sorghum Extract | |

Thus, the λmax of the anthocyanin is reduced to either 504 nm or 496.5 nm from 513 nm on addition of sorghum extract.

### Example 2

To determine the effect of pH on chroma and hue, elderberry extract in water was combined with sorghum extract a ratio of 1:1 color units. The pH of the blend was adjusted with 0.1 normal hydrochloric acid or with diluted 50% potassium hydroxide. The various blends were allowed to stand at ambient temperature for 24 hours. Chroma and hue are then determined by Hunter calorimeter. The results are shown in Table 3.

TABLE 3

| | Chroma | Hue |
|---|---|---|
| pH | | |
| 2.52 | 85.88 | 47.55 |
| 2.86 | 81.32 | 46.49 |
| 3.11 | 76.05 | 43.67 |
| 3.55 | 63.99 | 36.99 |
| 4.15 | 46.99 | 30.82 |
| 4.5 | 40.07 | 29.3 |
| Elderberry extract only @ pH 3.0 | 62.97 | 25.18 |
| Sorghum extract only @ pH 3 | 62.98 | 69.01 |

Accordingly, the present invention provides an edible coloring agent which can be added to food or beverages at any desired concentration to color the food red. Generally the food or beverage will have an acid pH. The present invention provides a color with increased chroma and hue. Further, it provides a color which is stable over a wide range of pHs.

This has been a description of the present invention, along with a preferred method of practicing the present invention, however, the invention itself should only be defined by the appended claims wherein we claim:

What is claimed is:

1. An food coloring agent comprising a combination of an aqueous anthocyanin solution and an aqueous sorghum extract.

2. The coloring agent claimed in claim 1 where the ratio of anthocyanin solution to sorghum extract based on color units is from 35:1 to 1:5.

3. The coloring agent claimed in claim 1 having a pH of 1.5 to 6.

4. The coloring agent claimed in claim 1 having a pH of 2 to 5.

5. The coloring agent claimed in claim 1 having a pH of 2.5 to 4.

6. The coloring agent claimed in claim 1 having a λmax of less than 513.

7. The coloring agent claimed in claim 1 wherein said sorghum extract is a black sorghum extract.

8. The coloring agent claimed in claim 7 wherein said sorghum extract is a sorghum bran extract.

9. A powdered food coloring agent comprising a dried blend of an aqueous anthocyanin solution and an aqueous sorghum extract.

10. A method of modifying the chroma and hue of an aqueous anthocyanin solution comprising adding to said anthocyanin solution an aqueous sorghum extract in an amount effective to increase said chroma and hue and decrease said λmax.
